(19) United States
(12) Patent Application Publication
(10) Pub. No.: US 2009/0254476 A1
(43) Pub. Date: Oct. 8, 2009

(54) METHOD AND SYSTEM FOR MANAGING PERSONAL AND FINANCIAL INFORMATION

(75) Inventors: Umesh Sharma, Vancouver (CA); Naresh Desai, North Vancouver (CA); Albert Meyburgh, Vancouver (CA); Lewis Zimmerman, Vancouver (CA); Lane Mearns, West Vancouver (CA)

Correspondence Address: NEXUS LAW GROUP LLP, 1500 - 701 WEST GEORGIA STREET, VANCOUVER, BC, V7Y 1C6, CA

(73) Assignee: QUICKRECEIPT SOLUTIONS INCORPORATED, Vancouver (CA)

(21) Appl. No.: 12/098,358

(22) Filed: Apr. 4, 2008

(51) Int. Cl. G06Q 40/00

(52) U.S. Cl. 705/39

(57) ABSTRACT

A system and method for managing personal and financial information is provided. The method involves: receiving financial transaction information for a purchase of the user, together with at least one attribute associated with the financial transaction information; storing the financial transaction information in association with the at least one attribute; and making the financial transaction information available for use under the control of the user. The attribute may be a financial account identifier, a financial account type, a purchase type or a purchase identifier. The method may also involve receiving a purchase location attribute defining a location for the purchase; determining a current location associated with a user mobile device using a global positioning system; and transmitting, if the purchase location attribute does not match the current location, a message to the mobile device for fraud detection purposes.

### BACKGROUND OF THE INVENTION

1. Field of Invention This invention relates to information management and, in particular, to a method and system for managing personal and financial information, including financial accounting information.

2. Description of Related Art

A variety of different methods and systems have been developed to facilitate various aspects of managing one's personal information and one's financial information.

Some systems can transmit an electronic receipt for a purchase made at a merchant's store by e-mail to the customer who made the purchase. Some systems permit an electronic receipt to be stored directly onto a smart card or other physical device. However, the electronic receipts of such systems contain limited information that exclude important information of use to the customer.

U.S. Pat. No. 7,200,578 issued to Paltenghe et al. discloses an information bank system in which different types of accounts are created to electronically store a consumer's information. Paltenghe et al. disclose means for collecting specified and limited types of personal financial information; means for providing security and access authorization controls; means for providing third party access to a consumer's information; means for providing an anonymous shopping service; means for providing a loyalty management program; and means for providing an important event, notification and response function. However, the means disclosed by Paltenghe et al. are limited and do not fully address the consumer's need for convenient data entry and for fraud detection.

### SUMMARY

The above shortcomings may be addressed by providing, in accordance with one aspect of the invention, a method of managing personal and financial information of a user having a user profile. The method involves: receiving financial transaction information for a purchase of the user, together with at least one attribute associated with the financial transaction information; storing the financial transaction information in association with the at least one attribute; and making the financial transaction information available for use under the control of the user.

Receiving financial transaction information for a purchase of the user, together with at least one attribute associated with the financial transaction information, may involve receiving at least one financial accounting attribute. Receiving at least one financial accounting attribute may involve receiving the at least one financial accounting attribute selected from the group consisting of: financial account identifier, financial account type, charge type and purchase identifier. Receiving at least one financial accounting attribute may involve receiving the at least one financial accounting attribute created in response to at least one prompt presented when the purchase is being made. Receiving the at least one financial accounting attribute created in response to at least one prompt presented when the purchase is being made may involve presenting a menu of financial accounting attributes to the user for selection by the user. Receiving financial transaction information for a purchase of the user, together with at least one attribute associated with the financial transaction information, may involve receiving the financial transaction information together with the at least one financial accounting attribute when the purchase is being made. The method may further involve receiving a purchase location attribute defining a location for the purchase. Receiving a purchase location attribute defining a location for the purchase may involve receiving the purchase location attribute when the purchase is being attempted. The method may further involve transmitting a user notification to the user indicating that the purchase is being attempted. The method may further involve determining a user location associated with the user. Determining a user location associated with the user may involve determining a current location of a mobile device specified in the user profile. Determining a current location of a mobile device specified in the user profile may involve using a global positioning system. The method may further involve transmitting, if the purchase location attribute does not match the current location, a message to the mobile device indicating that the purchase is being attempted. The method may further involve transmitting a merchant notification to a merchant associated with the purchase location attribute. The method may further involve making available to the user a notification produced in response to a request for the issuance by a government institution of a personal identity document associated with the user. The method may further involve receiving financial transactions information for a plurality of purchases of the user, receiving financial account statement information of the user, and making available for use under the control of the user one or more reports created on the basis of at least one of the financial transactions information and the financial account statement information. Making available for use under the control of the user one or more reports created on the basis of at least one of the financial transactions information and the financial account statement information may involve performing an operation selected from the group consisting of: providing secure electronic access to the user for viewing the one or more reports, providing secure electronic access to the user for downloading the one or more reports, and securely transmitting the one or more reports to a recipient specified by the user. The method may further involve transmitting to a merchant, at the time the purchase is being made from the merchant, an alias associated with the user.

In accordance with another aspect of the invention, there is provided a computer program product comprising computer executable instructions embodied in a signal bearing medium for performing a method of managing personal and financial information of a user having a user profile. The method involves: receiving financial transaction information for a purchase of the user, together with at least one attribute associated with the financial transaction information; storing the financial transaction information in association with the at least one attribute; and making the financial transaction information available for use under the control of the user.

In accordance with another aspect of the invention, there is provided a system for managing personal and financial information of a user having a user profile. The system includes: receiving means for receiving financial transaction information for a purchase of the user, together with at least one attribute associated with the financial transaction information; database storage means for storing the financial transaction information in association with the at least one attribute; and internet presence means for making the financial transaction information available for use under the control of the user.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a block diagram of a system for managing personal and financial information of a user, having a user profile, according to a first embodiment of the invention;

FIG. 2 is a flow diagram of a method in which a financial accounting attribute is received by the system shown in FIG. 1; and

FIG. 3 is a flow diagram of a method in which a purchase location attribute is received by the system shown in FIG. 1.

### DETAILED DESCRIPTION

A system for managing personal and financial information of a user having a user profile includes: receiving means for receiving financial transaction information for a purchase of the user, together with at least one attribute associated with said financial transaction information; database storage means for storing said financial transaction information in association with said at least one attribute; and internet presence means for making said financial transaction information available for use under the control of the user.

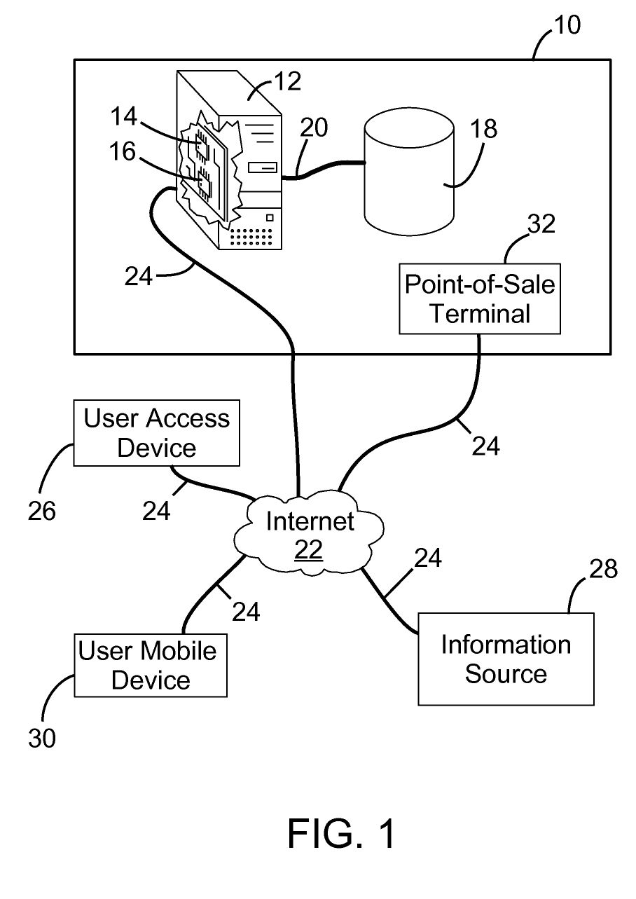

Referring to FIG. 1, the system according to a first and preferred embodiment of the invention is shown generally at 10.

The system 10 includes a server 12 having a processing circuit, such as the processor 14 shown in FIG. 1, and a memory circuit 16. The system also includes a database 18 shown in FIG. 1 as connected to the server 12 by a database connection 20.

The server 12 may be any computing device such as a general purpose computer, microcomputer, minicomputer, mainframe computer, distributed network for computing, functionally equivalent discrete hardware components and any combination thereof, for example.

The processor 14 is typically a processing circuit that includes one or more circuit units, such as a central processing unit (CPU), digital signal processor (DSP), embedded processor, etc., and any combination thereof operating independently or in parallel, including possibly operating redundantly. The processor 14 may be implemented by one or more integrated circuits (IC), including being implemented by a monolithic integrated circuit (MIC), an Application Specific Integrated Circuit (ASIC), a Field Programmable Gate Array (FGA), etc. or any combination thereof. The processor 14 may include circuitry for storing memory, such as digital data, and may comprise the memory circuit 16 or be in wired communication with the memory circuit 18, for example.

Typically, the memory circuit 16 and the database 18 are each all or part of a digital electronic integrated circuit. The memory circuit 16 and the database 18 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory circuit 16 and the database 18 may be operable to store memory as volatile memory, non-volatile memory, dynamic memory, etc. or any combination thereof.

The database 18 may be implemented as part of the processor 14, the memory circuit 16, or may be implemented separately from the server 12 as shown in FIG. 1. The database 18 typically functions to store information, typically in the form of recordable and retrievable data for use within or by the system 10, including data records stored in association with other data records. Secure storage is preferably provided by the system 10, which in some embodiments includes implementing regularly scheduled data backups and file recovery techniques. The database 18 may be implemented as a security database, for example.

The system 10 is typically operable to run one or more operating systems, including real-time and non-real time operating systems separately, simultaneously or redundantly. The system may be operable to implement multi-tasking methods involving multiple threads of executable code, for example.

The system 10 is preferably operable to communicate with other devices and systems via one or more communications networks, such as the Internet 22 shown in FIG. 1. The system 10 is connected to the Internet 22 by an internet connection 24. Additionally or alternatively, the system 10 may be operable to communicate with other devices and systems via one or more telecommunications networks, satellite networks, other similar communications networks, navigation networks, and any combination thereof. Although only implicitly shown in FIG. 1, the Internet 22 may include the one or more telecommunications networks, satellite networks, other similar communications networks, navigation networks, and any combination thereof.

The system 10 is preferably operable to securely communicate via the Internet 22. Secure communications may be accomplished by encryption techniques, for example. The system 10 is operable in some embodiments to generate encryption keys, including public and private keys, for the purposes of maintaining data security. The system 10 is also preferably operable to perform a hash function on data, including performing a hash function on data selected for secure communications, such as a credit card number for example, concatenated with other information, such as an identifier for a purchase receipt for example. Performing hash functions on concatenated information advantageously inhibits the creation of a hash lookup table for the purpose of unauthorized decryption of the information. In some embodiments, the physical computing resources required for secure communications are located separately from, but in communication with, that of other system 10 computing resources.

The system 10 is preferably operable to implement one or more Web pages of a system 10 website having a user interface present on the Internet 22. The system 10 website may be created using any suitable software platform, including the open source LAMP platform for example. The system 10 is operable to permit a user to connect to the system 10 website, maintain a secure connection to the system 10 website, create a user account, create a user profile, and enter personal information of the user that the user may wish to store in the database 18 under their user account. A user is typically a consumer who wishes to interact with a personal and financial information management system accessible by Internet 22 access, but may be any individual, business or institution.

The user can connect to the system 10 website from any communications device operable to connect to the Internet 22, such as the user access device 26 shown in FIG. 1. Examples of communications devices suitable for user as the user access device 26 include a personal home computer, desktop computer, laptop computer, dumb terminal for Internet 22 access, personal digital assistant, mobile telephone, etc. The user access device connects to the Internet 22 by the internet connection 24. While the internet connection 24 is shown in FIG. 1 as a wired connection, the internet connection 24 or portions thereof may be any wired or wireless connection, including a satellite link or line-of-sight free optical link for example. Additionally or alternatively, the internet connection 24 may include a fiber-optic transmission link. Thus, the system 10 provides a central depository feature which advantageously permits a user to manage and control their personal and financial information through Internet 22 access without the need for a smart card or other physical device and without the need for local data storage.

Personal identity information that a user may wish securely stored by the system 10 may include their name, address or other contact information, identifying numbers for or images of and/or copies of documents for driver licenses, passports, visas, birth certificates, medical and/or health policies, insurance policies, credit or debit card numbers, etc. The system 10 can also allow a user to securely store contact information for other individuals, businesses and institutions, for example.

Associating personal information, including personal information that has been verified to ensure accuracy of the information stored by the system 10, with a user account advantageously facilitates linking information received by the system 10 with the appropriate user. Preferably, the system 10 is operable to define at least one user identifier for each user or each user account to facilitate linking information received by the system 10 with a given user. Preferably, the system 10 stores the user identifier in association with the user profile. In some embodiments, the system 10 is operable to permit the user to select the user identifier and/or modify the user identifier. The system 10 is preferably operable to receive the user identifier as an attribute associated with other received information, thereby advantageously linking the received information to the user.

In the preferred embodiment, the system 10 is user-centric such that the user is given the authority to control the use of his or her personal information stored by the system 10. The system 10 maintains a user profile containing the user's preferences for the operation of the system 10 in respect of their user account, including preferences relating to access and distribution of the user's personal information.

Under the control and with the authorization of the user, the system 10 is operable to securely receive from the user or another source personal information of the user; securely store such personal information; permit the user to view the stored personal information such as by viewing through personal Web pages of the system 10 website; permit others to view the stored personal information; permit the user to download from the database 18 such personal information; and transmit such personal information to a recipient, including transmitting some or all of a user's personal information to the user or a third party designated by the user for example.

The system 10 is operable to communicate with any number of information sources 28, including receiving documents or other information and transmitting to the information sources 28 notices or other information. Such communications are preferably secure communications conducted under the control and with the authorization of the user, and are typically conducted via one or more internet connections 24. An information source 28 may include a database storing information respecting the user, and may include customer relationship management software for controlling such database or otherwise managing such information respecting the user. Examples of information sources include financial institutions, including banks, trust companies and credit unions; brokerage firms or companies; stock exchanges; official institutions, including government departments, government offices, universities, colleges, municipal offices or other government related institutions; and merchants, including store retailers, on-line electronic commerce (e-commerce) sellers and professional services providers. By way of example, the system 10 is preferably operable to receive copies of documents and other information from government departments or offices that issue (including re-issue) or process requests for the issuance (including re-issuance) of personal identification documents and from government departments or offices that process tax returns or related tax forms, and to transmit notices to the same. Examples of personal identification documents include birth certificates, passports, educational degree or diploma certificates, other official documents or official grants of status to an individual, for example. Further examples include bank notices, bank account statements and other banking or banking related information received from financial institutions; activity notices received from credit rating agencies; tax or identity documents received from government agencies; and promotional information received from businesses.

The information sources 28 can include databases with which the user is associated and databases of organizations for which the user is a member. Use of the system 10 data storage capabilities advantageously provides a secure backup service for users transmitting copies of documents or other information to be stored by the system 10. The system 10 is preferably operable to provide file level equivalency between the contents of the database 18 and the contents of databases of the information sources 28 that the user has caused to be transmitted to the database 18. File level equivalency advantageously facilitates recovery of data that is lost from the databases of the information sources 28.

As described further below, the system 10 is operable to transmit messages to a mobile device 30 of the user. Examples of the mobile device 30 can include a cellular telephone, satellite telephone, personal digital assistant, pager and other devices capable of receiving a message from an automated source. The mobile device 30 need not itself have internet access capabilities.

In the first embodiment, the system 10 is operable to execute software within electronic processing and memory circuitry in any number of point-of-sale (POS) terminals 32. The POS terminal 32 can be any device operable to generate a purchase receipt or image thereof, including a physical device located in a retail store for operation by a retail clerk, an on-line system for e-commerce, etc., for example. Typically, the POS terminal 32 is connected, either directly or indirectly through other communications electronics, to the Internet 22 via an internet connection 24, as shown in FIG. 1. The interface presented by the POS terminal 32 may involve the use of Application Programming Interface (API) technology.

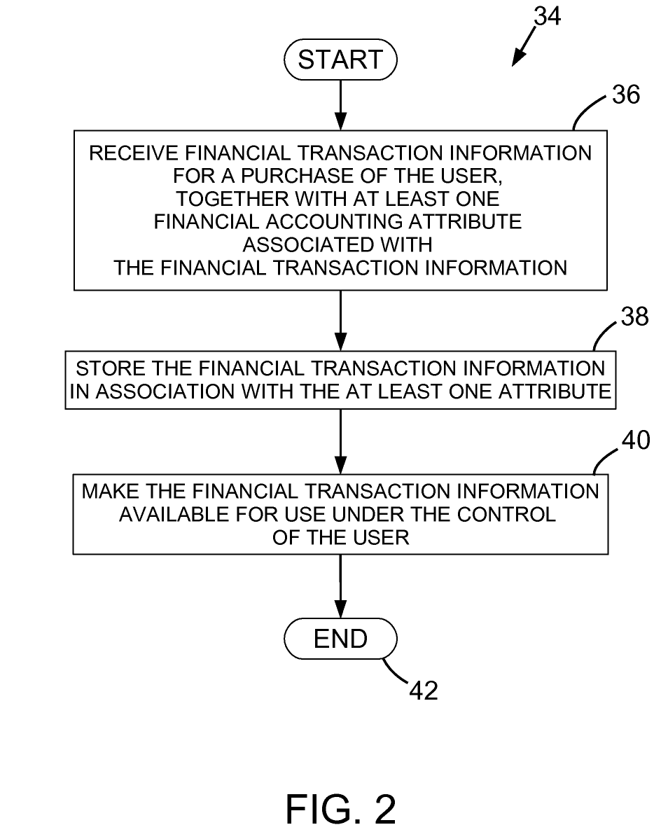

### FIG. 2

Referring to FIG. 2, the memory circuit 16 in accordance with the first embodiment of the invention contains blocks of code comprising computer executable instructions for directing the processor 14 to perform the steps of a method shown generally at 34. Additionally or alternatively, such blocks of code may form part of a computer program product comprising computer executable instructions embodied in a signal bearing medium, which may be a recordable computer readable medium or a signal transmission type medium, for example.

When electrical power is being supplied to the processor 14 and the memory circuit 16, the processor 14 is directed to begin executing the instructions of block 36. Block 36 directs the processor 14 to receive financial transaction information for a purchase of the user, together with at least one financial accounting attribute associated with the financial transaction information. A user can be making the purchase in-person at a physical location such as a retail store, by telephone from any location, including a home or work location, on-line from any location, etc., for example.

Financial transaction information typically provides proof of purchase to the user in the form of a digital receipt. To do so, the financial transaction information typically consists of an identification of the user and a list of purchase items and associated costs for each item, including relevant purchase prices and applicable taxes. The user may be identified by an account number for an account the user has with the merchant, such as a store membership number, credit card number, loyalty program number, customer benefits or purchase rewards membership number, on-line user account identifier, an e-mail address associated with the user, or other related means of identification. The financial transaction information also typically includes an identification of the merchant from which the purchase is being made and the date and/or time of the purchase. In some embodiments, the financial transaction information includes advertisements prepared by or otherwise associated with the merchant.

Examples of financial accounting attributes include a financial account identifier, a financial account type, a purchase type, a purchase identifier, etc. The financial accounting attribute may specify a tax category associated with a purchased item and/or a tax accounting code for a tax category or financial account. For example, the financial accounting attribute may specify that a given purchase should be accounted for under the tax category of deductible business expense or non-deductible personal expense, for example. Many other tax categories are possible. Purchases may be associated with types of expenses such as meals, car travel, taxis, hotels, air travel tickets, and virtually any accounting category that may be of convenience to the user. Account types and/or identifiers associated with an expense can identify the particular business, a group or section within a business, a project name, etc. The financial accounting attribute may specify an accounting code, which may have relevance only to a particular user or groups of users associated with the same business. Generic accounting codes may also be used as a financial accounting attribute. A plurality of financial accounting attributes may be combined or concatenated with the financial transaction information.

Preferably, the financial transaction information and the one or more associated financial accounting attributes are received from the POS terminal 32 (FIG. 1). Additionally or alternatively, other types of attributes can be received from the POS terminal 32. The system 10 preferably includes software being executed on or within the POS terminal 32 to prompt the user to provide the necessary details for an attribute when they are making their purchase or purchases. The user entry prompt may be implemented by API techniques installed in the POS terminal 32, for example. In some embodiments, the user entry prompt is executed under the control of the server 12. By way of example, menu selections may be presented to the user for selecting from among a plurality of tax categories such as “deductible” or “not deductible” or other suitable selections. The prompt may request the selection or the entry of category codes, for example, or may request indications of a tax category, tax account or customer identifier, and tax reason, for example. Additionally or alternatively, the user may be permitted to add free comments to specify one or more attributes for association with the financial transaction. The ability of the system 10 to prompt the user for associated attribute(s) advantageously provides convenient data entry.

In some embodiments, the financial transaction information and its associated attribute(s) are received from a given information source 28, which does not include system 10 software. In such cases, the information source 28 will typically connect to the system 10 website for securely uploading the financial transaction information and the associated attribute(s).

In some embodiments, the financial transaction information and the associated attribute(s) are transmitted from the merchant to the user who then transmits the financial transaction information and the associated attribute(s) to the server 12 of the system 10.

Additionally or alternatively, the system 10 in some embodiments is operable to receive electronically scanned copies of traditional paper purchase receipts. Associated attribute(s) may be written, including possibly hand written, on the paper receipt or provided in electronic form in association with the digital file containing the scanned image of the paper receipt.

The system 10 is preferably operable to receive financial transaction information and associated attribute(s) in real-time such that the financial transaction information and associated attribute(s) are being received when the user is making the purchase, or immediately upon making the purchase.

After receiving the financial transaction information and its associated attribute(s), block 38 then directs the processor 14 to store the received financial transaction information and the associated attribute(s) in association with each other. Typically, the received information and attribute(s) are stored in the database 18. The attribute(s) may specify a manner in which the financial transaction information is stored, such as by storing the financial transaction information in a database 18 record associated with other records in accordance with the contents of the attribute(s). By way of example, the financial transaction information may be associated in a database 18 record for “deductible business expenses” in association with a particular business identified by the contents of an associated attribute.

Block 40 then directs the processor 14 to make the stored financial transaction information and its associated stored attribute(s) available for use under the control of the user. The system 10 website can be accessed by the user for viewing their financial transaction history, including financial transaction information and associated attribute(s) for multiple purchases occurring over time, for example. Additionally or alternatively, the stored financial transaction information and its associated stored attribute(s) can be transmitted to the user by e-mail or provided by Really Simple Syndication (RSS) feed, for example. The system 10 is preferably operable to transmit information to the user by e-mail and/or RSS feed on a regularly scheduled basis in accordance with user parameters specified in the user profile. The system 10 is preferably operable to present financial transaction information according to the attribute(s) associated with the financial transaction information, such as by separately presenting financial transaction information associated with each tax category, for example. The system 10 website is preferably operable to present to the user their personal and financial information in a variety of presentation styles, including by table, chart, listing, etc. The user can filter stored information by keyword, value, merchant name, date, user identifier and by other suitable filtering parameters. The system 10 is preferably operable to permit a user to store filtering parameters and perform filtering on the basis of the stored filtering parameters.

The system 10 can make the stored financial transaction information available to one or more recipients, including recipients other than the user, under the control and with the authorization of the user. For example, the financial transaction information can be provided to the POS terminal 32 or information source 28, distributor, manufacturer or other third party in support of a product return or to otherwise exercise the user's rights related to a rebate, warranty or guarantee.

The system 10 is operable to provide personal and financial information of a user to a POS terminal 32, information source 28, automated payment system for the purpose of facilitating a payment, including for the purpose of validating a credit card payment for example, by secure communications under the control and with the authorization of the user. Examples of personal and financial information that might be provided include an identifier identifying the user or an alias of the user, credit or debit card number, bank account identifier, a mobile device 30 telephone number, other contact information, etc. Typically, the user profile includes the necessary authorization for such disclosure.

By way of further example, the system 10 is operable in some embodiments to transmit personal and financial information of a user, in accordance with the user profile, to a customer relationship management (CRM) system. Such information can be transmitted to facilitate the user's participation in a customer loyalty program or to otherwise accrue a benefit to the user, for example. In some embodiments, the system 10 is operable to transmit the information during a financial transaction such that the user receives a discount on the purchase being made.

In some embodiments, the system 10 is operable to make available financial transaction information to merchants who have, through the POS terminal 32 or information 28 for example, transmitted such financial information to the server 12. Typically, each merchant would have access only to the financial transaction or other information that originated with that merchant. The system 10 would permit filtered viewing, downloading and/or receiving by e-mail or RSS feed of such information.

The system 10 is preferably operable to generate reports associated with the stored financial transaction information and associated attribute(s). By way of example, the system 10 may cause an accounting reconciliation operation to be performed on the financial transaction information and other documents such as financial account statements, including bank statements, credit card statements, trust company statements, etc., received by the system 10 in respect of a given user. The result of the reconciliation operation is typically a reconciliation report that can be made available to the user. A typical reconciliation report includes indications of financial transactions that cannot be or have not been reconciled, to facilitate manual processing of such unreconciled financial transactions. Making a report available to the user can include permitting the user to view the report by accessing the system 10 website, permitting the user to download the report from the system 10 website, transmitting the report to a recipient specified by the user, including possibly e-mailing the report to the user or providing the report in a RSS feed, and transmitting the report to the user mobile device 30 for example.

Other types of reports can be generated. For example, a tax return may be generated, including possibly being generated by the system 10, and then made available to the appropriate government department or agency. A completed tax return may be made available to the government by uploading the tax return to a government server (not shown in the Figures) accessible through a government website, for example.

Further examples of reports that can be generated by the system 10 include summary and detailed accounting reports; suggested payment schedules for amounts owed; personal carbon savings reports indicating an environmental assessment of purchases made by the user and/or an amount of carbon savings accumulated by the user for their use in exchanging or selling; and activity reports of recent changes to the contents stored in the database 18 in association with the user, including notification reports of recent additions. Suggested payment schedule can be determined by the system 10 on the basis of projected bank balances, for example.

In addition to receiving, storing and making available the financial transaction information and its associated attribute(s), the system 10 is in some embodiments operable to convert the format of the financial transaction information and its associated attribute(s). For example, the system 10 might receive a number of separate communications from a number of different POS terminals 32. The different POS terminals 32 may be of different POS terminal types and/or operated by different merchants. Thus, the system 10 would then receive a plurality of separate communications of financial transaction information and associated attribute(s) in different formats. As part of any one of the steps of receiving, storing or making available the financial transaction information and attribute(s), or as a separate step in addition to such steps, the system 10 is in some embodiments operable to convert the format of the financial transaction information and attribute(s) from their transmitted format to a standard format for information and attribute management. Performing the format conversion after receiving the financial transaction information and attribute(s) advantageously permits the use of generic communications techniques. Performing the format conversion prior to storing the financial transaction information and attribute(s) in the database 18 advantageously permits the use of standardized storage techniques for all the financial transaction information and attribute(s).

Block 42 directs the processor to end the method 34.

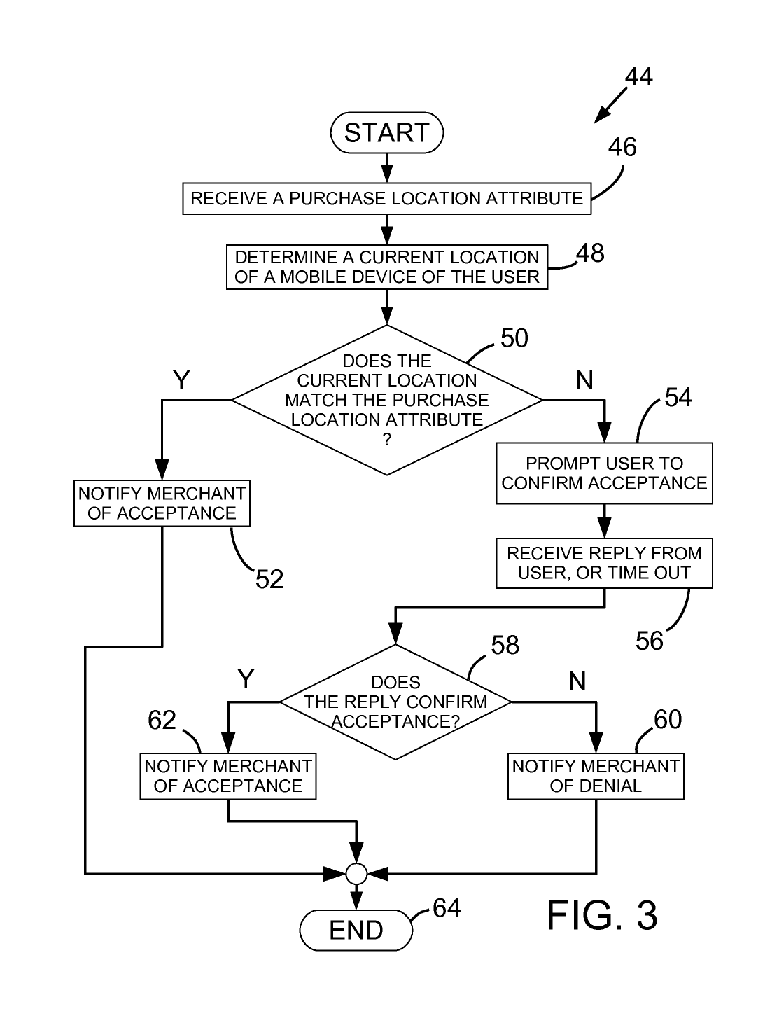

### FIG. 3

Referring to FIG. 3, the method shown generally at 44 begins with block 46 directing the processor 14 to receive a purchase location attribute. Preferably, the purchase location attribute defines a location for the purchase being made by a user. The purchase location attribute may be received in addition or alternatively to receiving any other associated attribute(s), including a financial accounting attribute, or other information, including financial transaction information. Typically, the purchase location attribute is received in real-time when the purchase is being attempted, and is preferably received before receiving the financial transaction information.

For clarity, the exemplary method shown in FIG. 3 will be described in relation to a credit card purchase occurring at a physical retail store location. However, in general, the embodiments of the invention are not limited to retail store purchases and the user could be making any kind of purchase from any location. The purchase may be made in-person, by telephone or on-line, for example.

The purchase location attribute can be received in any form suitable for identifying a location, including geographical coordinates, address information, location name, location code, etc., for example. In cases where a particular retail store or other seller is associated with only one location, the retail store or seller's name alone is sufficient to identify the purchase location. Preferably, however, the purchase location attribute is received in or received and converted to a form commensurate with location parameters of a Global Positioning System (GPS). In general, reference to GPS herein includes reference to any system operable to provide location coordinates, including any navigation satellite system, land-based triangulation system, or similar. A land-based triangulation system can perform triangulation calculations based on cellular telephone base stations and/or transmission towers, for example.

While, in some embodiments, the user can be prompted for the purchase location attribute, typically the POS terminal 32 (FIG. 1) or information source 28 (FIG. 1) transmits the purchase location attribute to the server 12 without first prompting the user for the purchase location. In some embodiments, the POS terminal 32 or the information source 28 transmits the purchase location attribute to the user, such as by e-mail or text message to their mobile device 30, who then can optionally transmit the purchase location attribute to the server 12.

After receiving the purchase location attribute, the system 10 is operable to determine a user location associated with the user. As shown in FIG. 3, block 48 directs the processor 14 to determine a current location of a mobile device of the user. Identifying information for the user mobile device 30 (FIG. 1) is preferably stored in the database 18 in association with the user profile for the given user. Thus, the user location can be determined by determining the current location of the user mobile device 30 specified in the user profile. The system 10 is preferably operable to invoke or otherwise use a GPS to determine the current location of the user mobile device 30. In some embodiments, the system 10 is operable to communicate with a GPS installed in the user mobile device 30 to determine its current location.

Block 50 then determines whether the current location of the user mobile device 30 matches the location indicated by the purchase location attribute. A match may be defined as being geographically near locations, such that there is a high probability that the user mobile device 30 is at the same place as the place where the purchase is being made.

If a match is found, the method proceeds to block 52 which directs the processor 14 to notify the POS terminal 32 or the information source 28 from which the purchase location attribute was received that the purchase is acceptable. In some embodiments, however, the method directly ends at block 64 without executing block 52 if a match is found.

If a match is not found after executing block 50, then block 54 directs the processor 14 to prompt the user to confirm or deny acceptance of the purchase. Typically, a user will confirm acceptance of the purchase if they are confident that the purchase is being legitimately made. However, a user may deny acceptance of the purchase in circumstances where, for example, the credit card purchase is being attempted at a purchase location distant from the current location of the user mobile device 30 after the user's credit card had been lost or stolen. The ability of the system 10 to confirm acceptance of a purchase with the user advantageously provides a method of fraud detection.

Notifying the user of a lack of match between the purchase location and the user mobile device 30 current location preferably involves sending a text message, voice message (including an electronically recorded voice message) or similar to the user mobile device 30. In general, however, the system 10 is operable to send a message to any communications device, including a land-line telephone or by e-mail to the user access device 26. Typically, the user profile will include a list of contact techniques for the system 10 to use. Additionally or alternatively, the message or similar requests or otherwise prompts the user to confirm or deny acceptance of the purchase being made.

Although not shown in FIG. 3, other criteria may be used in determining whether to notify the user and/or prompt the user for confirmation of a given purchase. Such other criteria can be stored in the user profile as user parameters. Examples of user parameters include a purchase amount threshold, purchase type, location boundaries, location type, other similar user parameters and any combinations thereof. By way of example, the system 10 is operable in some embodiments to only notify the user of a purchase occurring that involves a purchase amount greater than the purchase amount threshold, such as $500 or $5000 for example, specified in the user profile. Different purchase amount thresholds may be specified for different purchase types, such as credit card purchases at retail stores, on-line credit card purchases, etc, for example.

Different credit cards may be specified in the user profile for different treatment. Additionally or alternatively, the system 10 can notify the user only of purchases occurring within or outside of certain location boundaries. For example, a user may wish to be notified if a purchase is being attempted outside of their country, state or province, county, municipal region or other region is occurring. The system 10 is also operable in some embodiments to notify the user and/or prompt the user for confirmation where a purchase is being attempted at a location type specified in the user profile. Examples of different location types include night clubs, hotels, travel agencies, etc., for example.

Block 56 directs the processor 14 to wait for a reply from the user mobile device 30. If no reply is received within a specified time, a time-out occurs. In some embodiments, the reply is effected by having the user press a particular key, or combination of keys on a keypad of the user mobile device 30, for example. In some embodiments, the system 10 is operable to receive a voice command constituting the reply. Suitable replies might include key combinations or voice commands for “acceptable”, “not acceptable”, “wait”, “alert store security”, “notify the police”, etc.

Block 58 directs the processor 14 to determine whether the reply, if received, confirms acceptance of the purchase being made. If a reply was received by block 56 before a time-out and the reply indicates an acceptance of the purchase, then block 58 determines that the reply confirms acceptance of the purchase. The method then proceeds to block 60 which directs the processor 14 to notify the POS terminal 32 (FIG. 1) or the information source 28 (FIG. 1) that acceptance of the purchase has been confirmed. In some embodiments, however, the method directly ends at block 64 without executing block 60 if acceptance is confirmed.

If a reply was received by block 56 that denies acceptance of the purchase, or if no reply was received by block 56 before a time-out occurred, then block 58 determines that acceptance of the purchase has not been confirmed. The method then proceeds to block 62 which directs the processor 14 to notify the POS terminal 32 (FIG. 1) or the information source 28 (FIG. 1) that acceptance has been denied. Additionally or alternatively, a different notification message or code can be transmitted by the system 10 to the POS terminal 32 (FIG. 1) or the information source 28 (FIG. 1) depending on whether a time-out had occurred. For example, where a reply denying acceptance is received, a strong warning can be sent indicating that the purchase may be a fraudulent purchase with a lost or stolen credit card. Other steps, such as notifying authorities, including the police for example, can also be taken. Where no reply is received before the time-out occurs, a softer warning can sent that merely indicates the purchase is suspect and remains unconfirmed. Although not shown in FIG. 2, in some embodiments, the system 10 is operable to continue attempting to receive a reply from the user, including by transmitting messages to a plurality of communications devices identified in the user profile, after a first time-out occurs. Messages can be delivered to the POS terminal 32 or the information source 28, as the case may be, indicating that no reply has been received to date, but that attempts to obtain one are continuing. In some embodiments, no time-out is defined and the system 10 continues attempting to obtain a reply from the user until a reply is received or the POS terminal 32 or information source 28 indicates no further attempts are required, such as by transmitting financial transaction information indicating that the purchase has concluded. In some embodiments, however, the system 10 is operable to prohibit conclusion of a purchase until acceptance is confirmed.

Block 64 directs the processor to end the method 44. Typically, after the method 44 has been completed and unless the purchase is being prohibited by the system 10, the system 10 is operable to proceed to the method 34 shown in FIG. 2.

The method 44 shown in FIG. 3 also involves in some embodiments storing a complete history of determinations and communications occurring during the execution of method 44. Thus, the system 10 is operable to produce and retain evidence of fraudulent and potentially fraudulent use of the user's credit card, for example, and other suspect activities involving the user's personal and financial information, for submission to the authorities.

While the notification features of the method shown in FIG. 3 has been described primarily in relation to a credit card purchase being made, the system 10 is also operable to produce other notifications. For example, the system 10 is operable in some embodiments to alert the user that the system has received notification of a request for the issuance (including re-issuance) by a government institution of a personal identity document associated with the user. Additionally or alternatively, an alert can be provided to the user for any use of the user's identity for which the system 10 can receive notification. Typically, such alerts are provided in accordance with the user profile. In some embodiments, such alert is provided in real-time as it is occurring so that the user or the system 10 can take steps to thwart mis-use of one's identity. In such embodiments, when the system 10 receives notification from a government department or agency of the issuance or request for the issuance, of an identity document associated with the user, the system 10 is operable to report such fact to the user. The location of the issuance, or request therefor, may be determined by receiving a location attribute from the government department or agency, or by receiving an identification of the government department or agency and associating the identification with a location, for example. The user location may be determined by determining the current location of the user mobile device 30. The user location and the location at which the issuance, or request for the issuance, of the identity document is occurring can then be compared by the system 10. The system 10 is then operable to notify the user of the results of the comparison in accordance with the user profile. For example, the user profile may indicate that a text message should be sent to the user mobile device 30 if the locations do not match. In this manner, the system 10 can alert the user to the potential mis-use of their identity. In addition to alerting the user, the system 10 is operable in some embodiments to prompt the user to reply to a request for confirmation that the issuance of the personal identity document is legitimate. Absent confirmation that the issuance is legitimate, the system 10 is operable, in accordance with the user profile, to alert the appropriate government agency that the personal identity document should not be issued.

By way of further example, the system 10 is operable in some embodiments to alert the user whenever the system 10 determines that the number or frequency of credit card checks occurring with credit reporting agencies has exceeded a threshold number specified in the user profile.

Interactions between the system 10 and other entities on behalf of the user in accordance with the user profile are also possible. In some embodiments, the system 10 is in communication with one or more telephone systems regarding telephone call handling in accordance with the user profile. In such embodiments, the system 10 is operable to receive queries from the telephone system. Such queries may include requests confirmation that the user is willing to accept charges for specified telephone services. The user profile can include geographical and/or other limits to acceptable telephone services. The system 10 compares the confirmation request with the user profile and can notify the telephone system of the acceptability of a given telephone service, in real-time, prior to incurring any charges. Additionally or alternatively, the system 10 can specify an upper charge limit for a given type of telephone service, thereby limiting the service provided by the telephone system to keep costs below a user specified threshold level. As a further example, the system 10 is operable to maintain a list of blocked callers in the user profile. A query from the telephone system as to whether the user wishes to receive a telephone call from a given caller can be received by the system 10. The system 10 determines whether a given caller should be blocked in accordance with the user profile, and notifies the telephone system accordingly.

### Anonymous Purchases and Communications

The system 10 is operable in some embodiments to facilitate anonymous purchases by the user. Typically, anonymous purchases are on-line purchases, however, anonymity can be provided for any electronic communications. The user profile in such embodiments includes an alias for the user and the system 10 website permits a user to conduct electronic communications with a third party through the system 10 website. In some embodiments, the system 10 is operable to permit a single user to create multiple user accounts, each user account having a different user profile. In such embodiments, one user account is typically considered the primary user account associated with the true identity of the user and the other user accounts are associated with aliases. The true identity of the user can be verified at the time the primary user account is being created, such as by interviewing the user or performing other background checks for example. The system 10 website presents the alias, as identification of the user, to the third party when transmitting communications originating from the user. In this manner, the system 10 is operable to transmit to a merchant, such as by transmitting to an on-line (or virtual) POS terminal 30 or other information source 28, an alias associated with the user. Furthermore, the system 10 is operable to permit the user to retrieve information from an Internet 22 website without their true identity becoming known to sources of unsolicited advertisement. Additionally or alternatively, the system 10 is operable to permit a user to specify in their user profile their interests and hobbies, etc., for the purposes of receiving advertisements related to their interests and hobbies, etc. In some embodiments, the presentation of advertisements to the user is under the user's control and conducted only with the user's authorization. Advertisements can be received from information sources 28, POS terminals 32 and from businesses having business accounts associated with the system 10, for example.

While FIG. 2 shows a flow diagram for a method involving receiving a financial accounting attribute and FIG. 3 relates to a purchase location attribute, other attributes and types of attributes are possible. In some circumstances, only one attribute, which provides the user identifier, is received together with a given piece of information. In other circumstances, a combination of attributes, including attributes of different types, are received. In some embodiments, the system 10 is operable to receive redundant transmissions of attributes, thereby advantageously enhancing accuracy and/or security.

Thus, there is provided a method of managing personal and financial information of a user having a user profile, the method comprising: receiving financial transaction information for a purchase of the user, together with at least one attribute associated with said financial transaction information; storing said financial transaction information in association with said at least one attribute; and making said financial transaction information available for use under the control of the user.

While embodiments of the invention have been described and illustrated, such embodiments should be considered illustrative of the invention only. The invention may include variants not described or illustrated herein in detail. For example, the order in which the steps of the methods shown in the Figures may be varied, some steps may be omitted and additional steps may be included. Thus, the embodiments described and illustrated herein should not be considered to limit the invention as construed in accordance with the accompanying claims.

1. A method of managing personal and financial information of a user having a user profile, the method comprising:
(a) receiving financial transaction information for a purchase of the user, together with at least one attribute associated with said financial transaction information;
(b) storing said financial transaction information in association with said at least one attribute; and
(c) making said financial transaction information available for use under the control of the user.

2. The method of claim 1 wherein receiving financial transaction information for a purchase of the user, together with at least one attribute associated with said financial transaction information, comprises receiving at least one financial accounting attribute.

3. The method of claim 2 wherein receiving at least one financial accounting attribute comprises receiving said at least one financial accounting attribute selected from the group consisting of: financial account identifier, financial account type, charge type and purchase identifier.

4. The method of claim 2 wherein receiving at least one financial accounting attribute comprises receiving said at least one financial accounting attribute created in response to at least one prompt presented when said purchase is being made.

5. The method of claim 4 wherein receiving said at least one financial accounting attribute created in response to at least one prompt presented when said purchase is being made comprises presenting a menu of financial accounting attributes to the user for selection by the user.

6. The method of claim 2 wherein receiving financial transaction information for a purchase of the user, together with at least one attribute associated with said financial transaction information, comprises receiving said financial transaction information together with said at least one financial accounting attribute when said purchase is being made.

7. The method of claim 1 further comprising receiving a purchase location attribute defining a location for said purchase.

8. The method of claim 7 wherein receiving a purchase location attribute defining a location for said purchase comprises receiving said purchase location attribute when said purchase is being attempted.

9. The method of claim 8 further comprising transmitting a user notification to the user indicating that said purchase is being attempted.

10. The method of claim 8 further comprising determining a user location associated with the user.

11. The method of claim 10 wherein determining a user location associated with the user comprises determining a current location of a mobile device specified in the user profile.

12. The method of claim 11 wherein determining a current location of a mobile device specified in the user profile comprises using a global positioning system.

13. The method of claim 11 further comprising transmitting, if said purchase location attribute does not match said current location, a message to said mobile device indicating that said purchase is being attempted.

14. The method of claim 13 further comprising transmitting a merchant notification to a merchant associated with said purchase location attribute.

15. The method of claim 1 further comprising making available to the user a notification produced in response to a request for the issuance by a government institution of a personal identity document associated with the user.

16. The method of claim 1 further comprising receiving financial transactions information for a plurality of purchases of the user, receiving financial account statement information of the user, and making available for use under the control of the user one or more reports created on the basis of at least one of said financial transactions information and said financial account statement information.

17. The method of claim 16 wherein making available for use under the control of the user one or more reports created on the basis of at least one of said financial transactions information and said financial account statement information comprises performing an operation selected from the group consisting of: providing secure electronic access to the user for viewing said one or more reports, providing secure electronic access to the user for downloading said one or more reports, and securely transmitting said one or more reports to a recipient specified by the user.

18. The method of claim 1 further comprising transmitting to a merchant, at the time said purchase is being made from said merchant, an alias associated with the user.

19. A computer program product comprising computer executable instructions embodied in a signal bearing medium for performing a method of managing personal and financial information of a user having a user profile, the method comprising:
(a) receiving financial transaction information for a purchase of the user, together with at least one attribute associated with said financial transaction information;
(b) storing said financial transaction information in association with said at least one attribute; and
(c) making said financial transaction information available for use under the control of the user.

20. A system for managing personal and financial information of a user having a user profile, the system comprising:
(a) receiving means for receiving financial transaction information for a purchase of the user, together with at least one attribute associated with said financial transaction information;
(b) database storage means for storing said financial transaction information in association with said at least one attribute; and
(c) internet presence means for making said financial transaction information available for use under the control of the user.
